(19) United States
(12) Patent Application Publication
(10) Pub. No.: US 2024/0228310 A1
(43) Pub. Date: Jul. 11, 2024

(54) MAGNESIUM REMOVAL PROCESS

(71) Applicant: Lithium Nevada Corporation, Reno, NV (US)

(72) Inventors: Ryan Michael Ravenelle, Reno, NV (US); Hugh Broadhurst, Reno, NV (US); Dustin D. Whitehead, Herriman, UT (US); Shyamsundar Ayalur Chattanathan, Prairieville, LA (US); Rene LeBlanc, Johns Creek, GA (US)

(21) Appl. No.: 18/151,228

(22) Filed: Jan. 6, 2023

(51) Int. Cl. C01D 15/00; C01D 5/12; C01F 5/22; C01F 5/40

(52) U.S. Cl. CPC C01D 15/00; C01D 5/12; C01F 5/22; C01F 5/40

(57) ABSTRACT

A method for removing alkali earth metals from a filtrate including a first crystallization step and a second crystallization step, wherein the first crystallization step is a forced circulation crystallizer, and wherein the second crystallization step is a draft tube crystallizer. Also included is a method for reducing magnesium in a chemical liquor including crystallizing magnesium into a magnesium sulfate hydrate in a first crystallization step and precipitating magnesium via addition of a caustic material in a chemical precipitation step.

### TECHNICAL FIELD

This disclosure relates to removal of alkaline and alkaline earth metals from chemical processes. More specifically, this disclosure relates to magnesium sulfate via crystallization.

### BACKGROUND

Typical processes for purifying lithium often require removal of other impurities, such as magnesium, from the ore. The removal of magnesium is often necessary as it is substantially more abundant (up to ˜20× more abundant) than lithium in various ores in normal circumstances. Currently, chemical precipitation with quicklime or another caustic material is the preferred method, which has a high operational cost. The slurry, after mixing with quicklime, must be filtered to remove solids from liquid. With pure chemical precipitation, a large amount of cake is generated and is essentially a waste product that must be stored. Any brine contained within this filter cake may be recovered because it contains dissolved lithium. A typical method is to try and “wash” the filter cake in a filter press; however, this is difficult, time consuming, and likely not very efficient with this material. Typical crystallization methods may result in undesired lithium containing salt formation and product losses.

### SUMMARY

Disclosed is a method for removing alkali earth metals from a filtrate including a first crystallization step and a second crystallization step, wherein the first crystallization step is a forced circulation crystallizer, and wherein the second crystallization step is a draft tube crystallizer.

Also disclosed is a method for reducing magnesium in a chemical liquor including crystallizing magnesium into a magnesium sulfate hydrate in a first crystallization step and precipitating magnesium via addition of a caustic material in a chemical precipitation step.

Also disclosed is a method for reducing alkali earth metals in solids including acid leaching the solids to form an effluent slurry, neutralizing the effluent slurry to form a neutralized filtrate, concentrating the neutralized filtrate by Mechanical Vapor Recompression heated falling film evaporators, crystallizing impurities from the neutralized filtrate in a first crystallization step in a forced circulation crystallizing step, crystallizing impurities from the neutralized filtrate in a second crystallization step in a first draft tube crystallizing step, crystallizing impurities from the neutralized filtrate in a third crystallization step in a second draft tube crystallizing step and precipitating remaining impurities via addition of a caustic material.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures may be designated by matching reference characters for the sake of consistency and clarity.

FIG. 1 is a process of sequential crystallizing steps.

FIG. 2 is a process of a crystallization step before a precipitation step.

FIG. 3 is a process for removing magnesium from lithium solids.

FIG. 4a is a phase boundary diagram at 75° C. for magnesium, lithium, and potassium sulfate salts.

FIG. 4b is a phase boundary diagram at 50° C. for magnesium, lithium, and potassium sulfate salts

FIG. 4c is a phase boundary diagram at 35° C. for magnesium, lithium, and potassium sulfate salts.

FIG. 4d is a phase boundary diagram at 25° C. for magnesium, lithium, and potassium sulfate salts.

FIG. 4e is a phase boundary diagram at 0° C. for magnesium, lithium, and potassium sulfate salts.

### DETAILED DESCRIPTION

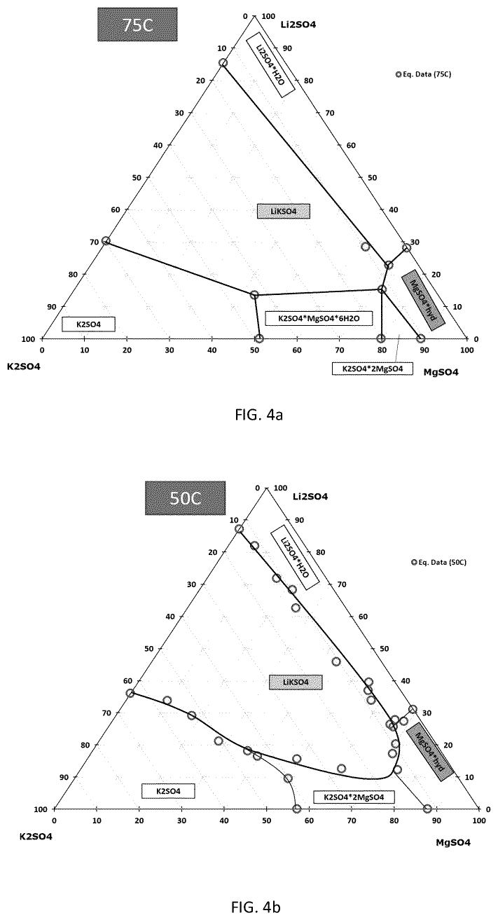

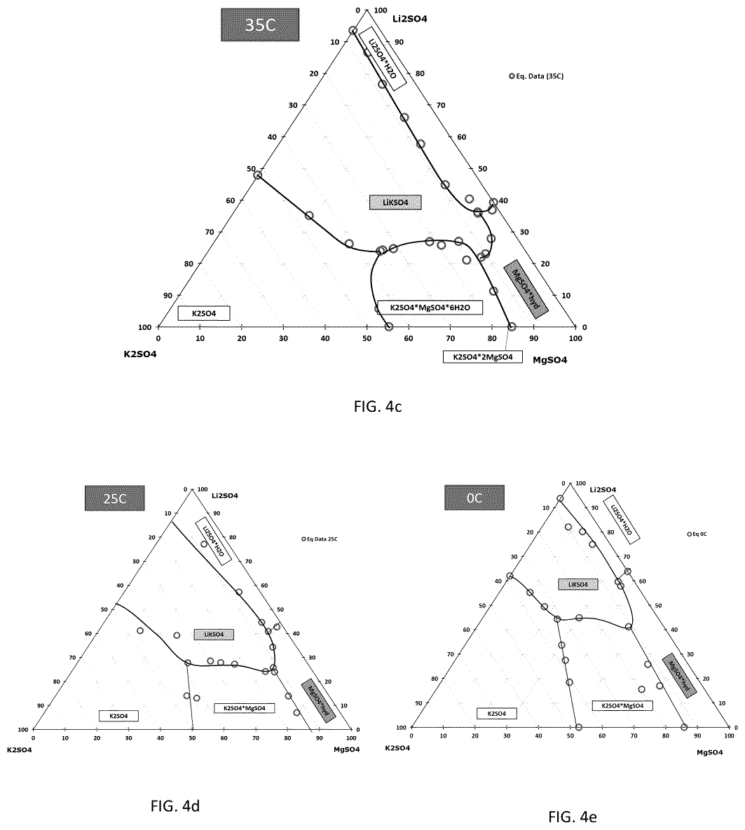

Disclosed is a method for removing alkaline earth metals from filtrates or solids and associated methods, systems, devices, and various apparatus. The method includes a step of crystallization of the alkaline earth metal from a filtrate in order to better yield alkali metals, specifically lithium. Crystallization of magnesium occurs in the form of magnesium sulfate hydrates. These magnesium sulfate hydrates are advantageous because of large crystal size and efficient washing. In addition, the crystallization of magnesium removes water from the process, which then does not have to be removed later in the process by evaporation. This water removal also concentrates the product in preparation for further processing, such as lithium carbonate production. Further, because the concentration of magnesium in the brine that remains is known as shown in FIG. 4a, FIG. 4b, FIG. 4c, FIG. 4d, and FIG. 4e, the amount of caustic materials needed for precipitation of the remainder is more easily predicted.

With pure chemical precipitation without crystallization, a large amount of cake is generated and is a waste product. Brine must be removed from the cake before discarding it through washing the filter cake. The waste flows in each step can be recycled to be washed in a countercurrent decantation (CCD) step and filtration step to ensure as little brine as possible remains in the filter cake. By crystallizing the impurities before the precipitation, the amount of cake containing magnesium hydroxide is less and the generated cake can be recycled in the neutralization step. Further, the reagent consumption for the precipitation is lessened as well. After the precipitation of magnesium, a second precipitation step of calcium can be added. Filtrate from the magnesium precipitation step can be mixed with a 25 wt. % soda ash (Na₂CO₃) solution to precipitate calcium carbonate (CaCO₃). Flocculants and coagulants can be added to facilitate solids settling and removal. As an example, ferric sulfate can be added as coagulant.

It would be understood by one of skill in the art that the disclosed method is described in but a few exemplary aspects among many. No particular terminology or description should be considered limiting on the disclosure or the scope of any claims issuing therefrom.

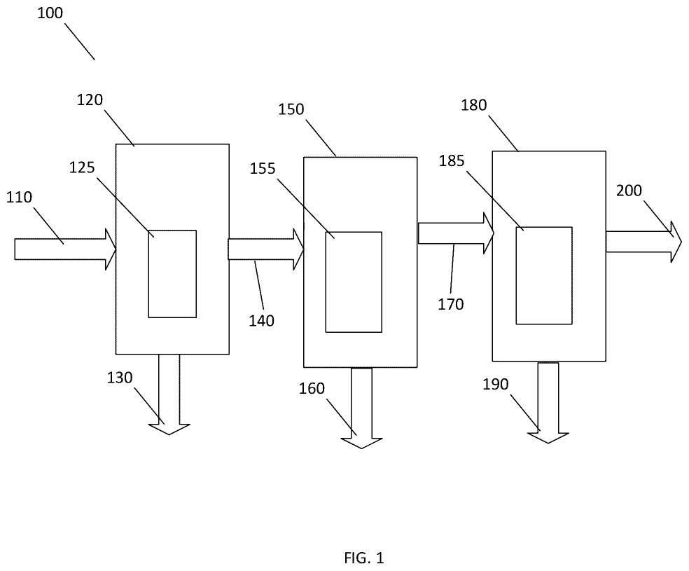

One aspect of removing alkali earth metals from filtrates is disclosed and described in FIG. 1.

FIG. 1 shows a process 100 with an inflow stream of chemical filtrate 110. The chemical filtrate 110 can contain various desirable cations, such as alkali metal cations, specifically lithium, and various undesirable cations or impurities such as calcium, magnesium or potassium. In some aspects, the magnesium is up to 20× more abundant than the desired lithium cations. The chemical filtrate 110 can comprise a sulfate solution. The chemical filtrate 110 can flow to a first crystallization step 120.

The first crystallization step 120 can comprise a forced circulation crystallizer 125. The forced circulation crystallizer 125 can operate at a temperature range of 75° C. to 55° C., more specifically approximately 65° C. In the current aspect, “approximately” for a temperature value is defined as a range of +5° C. The forced circulation crystallizer 125 can be a Mechanical Vapor Recompression (“MVR”) heated forced circulation crystallizer operating under vacuum via vacuum pumps or through other vacuum control methods including but not limited to ejector/condenser trains. The first crystallization step 120 can comprise a waste flow 130 and a filtrate flow 140 exiting the first crystallization step 120.

The forced circulation crystallizer can be one type of evaporative crystallizer implemented. The forced circulation crystallizer composed of a crystal chamber, a circulation pipe, a circulating pump and a heat exchanger. The crystallization chamber can discharge slurry from the bottom, and a circular tube axial flow type circulating pump through the heat exchanger is heated again into the crystallization chamber. The forced circulation crystallizer may be a mixed-suspension, mixed-product removal (MSMPR) crystallizer for continuous operation. An MSMPR crystallizer can also be a draft tube crystallizer or draft tube baffle crystallizer. A draft tube crystallizer can comprise various elements, such as a crystallizer vessel, impeller pump to provide circulation along the draft tube, a circulation pump to provide external circulation, and a heat exchanger to supply thermal energy for the desired crystallization rate. A draft tube crystallizer can also comprise a baffle to become a draft tube baffle crystallizer, where the baffle controls a crystal population by separating fine crystals from coarse crystals.

The waste flow 130 can contain crystallized impurities in a slurry form, such as MgSO₄, CaSO₄, K₂SO₄, or hydrates and mixtures thereof. The crystals in the waste flow 130 can then be dewatered and washed to create a liquor that is then sent to a next crystallization step 150.

Filtrate flow 140 can contain a lower amount of impurities than the inflow stream filtrate flow 110. Filtrate flow 140 can then flow to the second crystallization step 150. The second crystallization step 150 can contain a first draft tube type crystallizer 155. The second crystallization step 150 can operate at a temperature range of 30° C. to 50° C., more specifically approximately 40° C. In the current aspect, “approximately” for a temperature value is defined as a range of +5° C. Water vapor and non-condensable gases can be removed from the second crystallization step 150 by ejector/barometric condenser trains cooled by cooling tower water. The ejector condenser train can be a combination of an ejector removing air and water vapor to maintain a constant pressure and a condenser which condenses the used steam. The vacuum control can also be by other methods, including but not limited to vacuum pumps. The cooling tower water temperature can control the operating temperature of the second crystallization step 150. The second crystallization step 150 can comprise a waste flow 160 and a filtrate flow 170 exiting the second crystallization step 150.

The waste flow 160 can contain crystallized impurities in a slurry form, such as MgSO₄, CaSO₄, K₂SO₄ or hydrates and mixtures thereof. The crystals in the waste flow 160 can then be dewatered and washed to create a liquor that is then sent to a next crystallization step 180.

Filtrate flow 170 can contain a lower amount of impurities than filtrate flows 140, 110. Filtrate flow 170 can then flow to a third crystallization step 180. The third crystallization step 180 can contain a second draft tube type crystallizer 185. The third crystallization step 180 can operate at a temperature range of 1° C. to 20° C., more specifically approximately 10° C. In the current aspect, “approximately” for a temperature value is defined as a range of ±5° C. Water vapor and non-condensable gases can be removed from the third crystallization step 180 by indirect condenser/ejector trains cooled by chilled water. The chilled water can also instead be ethylene glycol, propylene glycol, a water mixture with the glycols, or other suitable cooling liquid in some aspects. The chilled water temperature can control the operating temperature of the third crystallization step 180. The third crystallization step 180 can comprise a waste flow 190 and an outstream flow 200 exiting the third crystallization step 180. The crystals in the waste flow 190 can also be dewatered and washed to create a liquor that is then recycled to a previous crystallization step.

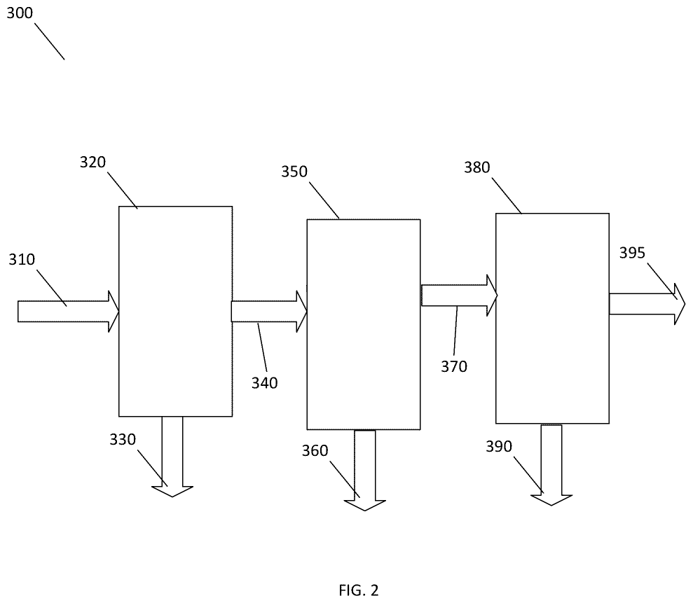

FIG. 2 illustrates a process 300 with an inflow stream of chemical liquor 310, at least a first crystallization step 320, and at least a precipitation step 380. The chemical liquor 310 can contain various desirable cations, such as alkali metal cations, specifically lithium, and various undesirable cations or impurities such as calcium, magnesium, or potassium. In some cases, the magnesium is up to 20× more abundant than the desired lithium cations. The chemical liquor 310 can comprise a sulfate solution.

The chemical liquor 310 can first flow into the first crystallization step 320. The first crystallization step 320 can be an evaporative crystallization process. The evaporative crystallization can be via an MVR-heated forced circulation crystallizer operating under vacuum via vacuum pumps or through other vacuum control methods including but not limited to ejector/condenser trains. The first crystallization step 320 can operate at a temperature range of 55° C. to 35° C., more specifically approximately 40° C. In the current aspect, “approximately” for a temperature value is defined as a range of +5° C. The first crystallization step 320 can comprise a waste flow 330 and a liquor flow 340 exiting the first crystallization step 320.

The waste flow 330 can contain crystallized impurities in a slurry form, such as MgSO₄. CaSO₄, K₂SO₄ or hydrates and mixtures thereof. The crystals in the waste flow 330 can then be dewatered and washed to create a liquor that is then sent to a next crystallization step 350.

Liquor flow 340 can contain a lower amount of impurities than the inflow stream chemical liquor 310. Liquor flow 340 can then flow to the second crystallization step 350. The second crystallization step 350 can be through a cooling crystallization process carried out by draft tube type crystallizer. The second crystallization step 350 can operate at a temperature range of 15° C. to 1° C., more specifically approximately 10° C. In the current aspect, “approximately” for a temperature value is defined as a range of +5° C. During cooling crystallization, no LiKSO₄ is formed. Over 50% of the Mg and over 20% of the potassium can be removed during the cooling crystallization step. In both the evaporative and cooling crystallization, the magnesium crystallizes as either MgSO₄·6H₂O, MgSO₄·7H₂O, other hydrates or combinations thereof depending on temperature. In both the evaporative and cooling crystallization, potassium may also crystallize as potassium sulfate, potassium sulfate hydrates, magnesium potassium sulfate, magnesium potassium sulfate hydrates, magnesium potassium double salts, or combinations thereof. The second crystallization step 350 can comprise a waste flow 360 and a liquor flow 370 exiting the first crystallization step 350.

The waste flow 360 can contain crystallized impurities in a slurry form, such as MgSO₄, CaSO₄, K₂SO₄ or hydrates and mixtures thereof. The crystals in the waste flow 360 can then be dewatered and washed to create a liquor that is then sent to the precipitation step 380.

Liquor flow 370 can contain a lower amount of impurities than liquor flow 340. Liquor flow 370 can then flow to the chemical precipitation step 380. The chemical precipitation step 380 can comprise mixing the liquor flow 370 with a caustic material such as a 25 wt. % milk-of-lime slurry to adjust the pH to approximately 11 to precipitate magnesium as magnesium hydroxide. In the current aspect, “approximately” for a pH value is defined as a range of ±0.5. Calcium can also be coprecipitated during the chemical precipitation step 380. The calcium can be coprecipitated as calcium sulfate or calcium sulfate hydrates thereof depending on temperature. Magnesium can be precipitated to about 5 ppm in a single agitated tank with a retention time of 1 hour. Calcium can remain at saturation level. The chemical precipitation step 380 can comprise a waste flow 390 and an outflow stream 395 exiting the chemical precipitation step.

TABLE 1
Two-step crystallization and precipitation data

| | | | | |
|---|---|---|---|---|
| Test # | 1 | 2 | 3 | 4 |

| Target [Li] in evaporation ML, | | 0.600 | 0.400 | 0.500 | 0.600 |
|---|---|---|---|---|---|
| wt. % | | | | | |
| Crystallization | Evaporative | 45 | 45 | 45 | 45 |
| Temp ° C. | Cooling | 5 | 5 | 5 | 5 |

| | Li | Mg | K | Li | Mg | K | Li | Mg | K | Li | Mg | K |
|---|---|---|---|---|---|---|---|---|---|---|---|---|
| Evaporative feed, wt % | 0.141 | 2.30 | 0.683 | 0.141 | 2.30 | 0.683 | 0.141 | 2.30 | 0.683 | 0.141 | 2.30 | 0.683 |
| Evaporation ML, wt % | 0.605 | 6.11 | 2.47 | 0.405 | 6.19 | 1.83 | 0.440 | 6.03 | 2.15 | 0.652 | 5.66 | 3.05 |
| Cooling crystallization ML | 0.992 | 3.70 | 1.94 | 0.625 | 3.98 | 1.99 | 0.688 | 3.84 | 1.69 | 1.010 | 3.50 | 1.65 |
| wt % | | | | | | | | | | | | |
| Evaporative precipitation % | 27 | 57 | 26 | 0 | 9 | 6 | 2 | 20 | 2 | 0 | 42 | 0 |
| Cooling precipitation % | 0 | 59 | 29 | 0 | 54 | 24 | 0 | 56 | 41 | 0 | 54 | 61 |
| Overall precipitation % | 27 | 74 | 38 | 0 | 55 | 27 | 0 | 58 | 35 | 0 | 67 | 38 |

| Test # | | 5 | 6 | 7 |
|---|---|---|---|---|
| Target [Li] in evaporation ML, | | 0.400 | 0.500 | 0.750 |
| wt. % | | | | |
| Crystallization | Evaporative | 45 | 45 | 35 |
| Temp ° C. | Cooling | 25/5 | 5 | 5 |

| | Li | Mg | K | Li | Mg | K | Li | Mg | K |
|---|---|---|---|---|---|---|---|---|---|
| Evaporative feed, wt % | 0.141 | 2.30 | 0.683 | 0.141 | 2.30 | 0.825 | 0.141 | 2.30 | 0.683 |
| Evaporation ML, wt % | 0.416 | 6.03 | 2.00 | 0.518 | 5.95 | 2.64 | 1.580 | 5.17 | 3.07 |
| Cooling crystallization ML | 0.664 | 3.99 | 1.82 | 0.625 | 3.98 | 1.99 | 0.688 | 3.84 | 1.69 |
| wt % | | | | | | | | | |
| Evaporative precipitation % | 1 | 15 | 2 | 0 | 9 | 6 | 2 | 20 | 2 |
| Cooling precipitation % | 0 | 15/47 | 0/33 | 0 | 54 | 24 | 0 | 56 | 41 |
| Overall precipitation % | 0 | 65 | 33 | 0 | 55 | 27 | 0 | 58 | 35 |

Table 1 is exemplary data from a bench-test of the process in FIG. 2, comprising a first crystallization stage (see evaporative precipitation %), a second crystallization stage (see cooling precipitation %). All tests other than the fifth and seventh tests comprises a first evaporative crystallization stage at 45° C., and a second cooling crystallization stage at 5° C. The fifth test is actually two tests, and is an adiabatic process and comprises a first evaporative crystallization stage at 45° C., and a second cooling crystallization stage at either 25° C. or 5° C. The seventh test comprises a first evaporative crystallization stage at 35° C., and a second cooling crystallization stage at 5° C.

The first through fourth, sixth, and seventh tests targeted a specified concentration of lithium in solution after evaporation, measured by parts per million (ppm). The test parameters included temperature, lithium, concentration, pH, K:Li ratio. As shown by Table 1, all the tests resulted in substantially no lithium precipitation during the evaporative crystallization. The Table 1 tests also show high magnesium (over 50%) and potassium (over 20%) removal during cooling crystallization. There was also substantially no lithium containing salt formation during cooling crystallization at these parameters.

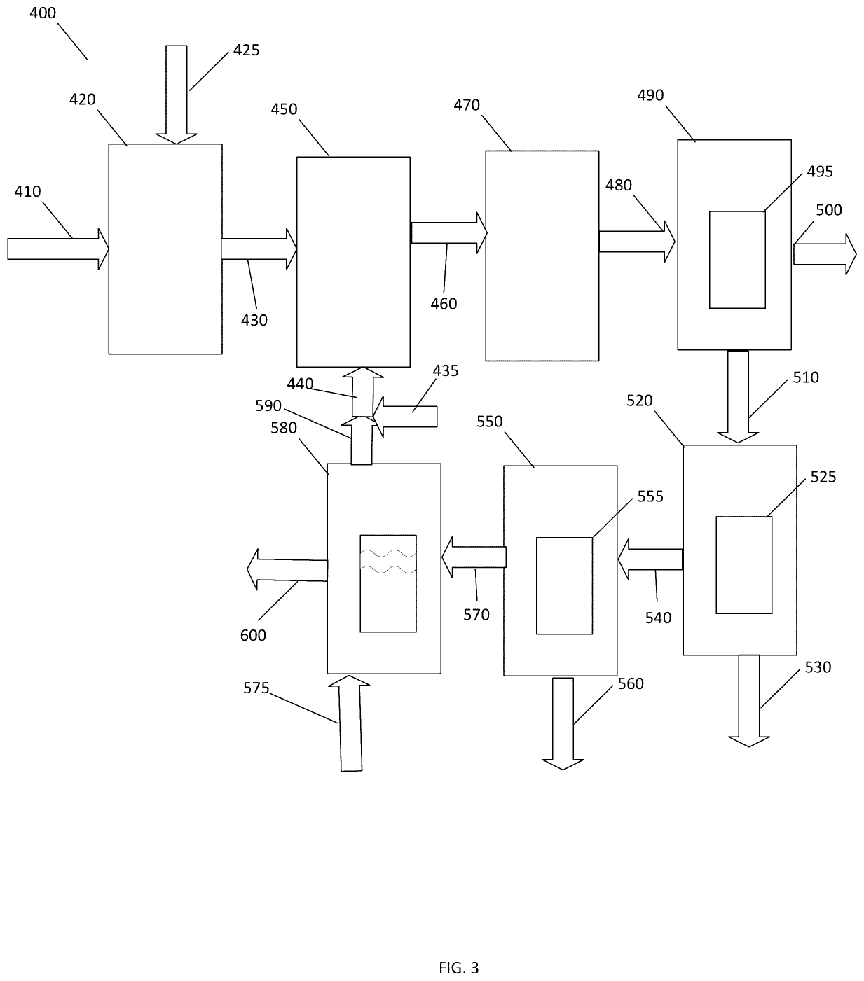

FIG. 3 illustrates a process 400 with an inflow stream of solids 410, with an acid-leaching step 420, a neutralization step 450, a concentration step 470, a first crystallization step 490, a second crystallization step 520, a third crystallization step 550, and a precipitation step 580. These solids 410 can be clay, limestone, ore, or other materials that contain lithium. These solids 410 can also contain a number of undesired impurities, such as potassium, magnesium, sodium, iron, boron, aluminum, or calcium. The solids 410 are first acid-leached in the acid-leaching step 420. Due to the non-selective acid leaching, undesired impurities can be leached into solution along with the lithium. The leach temperature of 75-90° C. can be governed by heat generated from the dilution of sulfuric acid and acid-solids reactions. In some aspects, continuous leaching can be performed in three agitated tanks in series at 1 hour leaching time each. Acid addition can be 490 kg of 100% H₂SO₄ per ton of leach feed solids. The acid leaching step 420 by addition of an acid 425, for example H₂SO₄, produces an effluent slurry 430.

The effluent slurry 430 is then neutralized in a neutralization step 450 to form a neutralized stream. A magnesium hydroxide stream 590 recycled from the downstream precipitation step 580 can be used to neutralize the effluent slurry 430 to a pH of approximately 6.5. In the current aspect, “approximately” for a pH value is defined as a range of ±0.5.

In some aspects, a two-step neutralization will be performed in agitated tanks, one per step, with a retention time of 1.5 hours in the first tank and 1 hour in the second. In the first step, a 30-40 wt. % slurry of ground limestone can be combined with the acidic slurry to increase a pH of the acidic slurry to a target, preferably less than or equal to 4. The first step neutralization can neutralize most of the residual acid from acid leach and precipitate most of the iron and aluminum. The magnesium hydroxide stream 590 recycled from the downstream precipitation step 580 can be used to neutralize the effluent slurry 430 to a pH of approximately 6.5. A stream 435 of limestone can be added to the magnesium hydroxide stream 590 to form the neutralizing stream 440.

The neutralized stream can undergo a solid/liquid separation, for example but not limited to pressure filtration, to generate a neutralized filtrate 460 liquid stream and a solids containing stream (not shown). The solids can be conveyed to a storage facility. Prior to solid/liquid separation, the slurry can undergo a brine recovery step, for example but not limited to Counter-Current-Decantation washing. In another aspect of brine recovery, slurry within the solid/liquid separator (e.g. filter press) can be washed with another liquid, such as raw water or condensate, to displace brine with the washing liquid to facilitate recovery of lithium within the brine solution.

The neutralized filtrate 460 can be concentrated in a concentration step 470 by MVR heated falling film evaporators prior to crystallization. An MVR heated falling film evaporator can concentrate the filtrate by heating the filtrate as it flows down along walls of tube-shaped heat exchangers within it, where the filtrate forms a film along the tube walls. The concentration can be via evaporation. The lithium concentration can be held below a target concentration leaving the evaporator to avoid crystallizing a lithium-potassium double salt. A seed recycle system can be used to minimize the amount of scaling, for example, caused by gypsum precipitation, in this step. Other risks of the concentration step can include encrustation, for example, by picromerite or schoenite. The scaling or encrustation risks vary depending on the impurities and type of solids used in the process. The concentration step 470 can occur at a temperature between 95° C. and 105° C. After the concentration step, concentrated neutralized filtrate 480 can flow to a first crystallization step 490.

The first crystallization step 490 can comprise a forced circulation crystallizer 495. The forced circulation crystallizer 495 can operate at a temperature range of 75° C. to 55° C., more specifically approximately 65° C. In the current aspect, “approximately” for a temperature value is defined as a range of +5° C. The forced circulation crystallizer 495 can be an MVR heated forced circulation crystallizer operating under vacuum via vacuum pumps, or through other vacuum control methods including but not limited ejector/condenser trains. The first crystallization step 490 can also include a separation of filtrate from solids via centrifuges. The first crystallization step 490 can comprise a waste flow 500 and a filtrate flow 510 exiting the first crystallization step 490.

The waste flow 500 can contain crystallized impurities in a slurry form, such as MgSO₄. CaSO₄, K₂SO₄, hydrates, or mixtures thereof. The crystals in the waste flow 500 can then be dewatered and washed to create a liquor that can then be sent to the next crystallization step 520 or recycled to the concentration step 470.

Filtrate flow 510 can contain a lower amount of impurities than the inflow stream of solids 410. Filtrate flow 510 can then flow to the second crystallization step 520. The second crystallization step 520 can contain a first draft tube type crystallizer 525. The second crystallization step 520 can operate at a temperature range of 30° C. to 50° C., more specifically approximately 40° C. In the current aspect, “approximately” for a temperature value is defined as a range of ±5° C. Water vapor and non-condensable gases can be removed from the second crystallization step 520 by ejector/barometric condenser trains cooled by cooling tower water. The cooling tower water temperature can control the operating temperature of the second crystallization step 520. The second crystallization step 520 can also include a separation of filtrate from solids via centrifuges. The second crystallization step 520 can comprise a waste flow 530 and a filtrate flow 540 exiting the second crystallization step 520.

The waste flow 530 can contain crystallized impurities in a slurry form, such as MgSO₄, CaSO₄, K₂SO₄, hydrates, or mixtures thereof. The crystals in the waste flow 530 can then be dewatered and washed to create a liquor that is then sent to a next crystallization step 550 or recycled to the concentration step 470.

Filtrate flow 540 can contain a lower amount of impurities than filtrate flows 510, or solids 410. Filtrate flow 540 can then flow to a third crystallization step 550. The third crystallization step 550 can contain a second draft tube type crystallizer 555. The third crystallization step 550 can operate at a temperature range of 1° C. to 20° C., more specifically approximately 10° C. In the current aspect, “approximately” for a temperature value is defined as a range of +5° C. Water vapor and non-condensable gases can be removed from the third crystallization step 550 by indirect condenser/ejector trains cooled by chilled water. The chilled water can also comprise a glycol mixture, such as ethylene glycol, propylene glycol, a mixture of water and the glycols, or other suitable cooling liquid. The chilled water temperature can control the operating temperature of the third crystallization step 550. The third crystallization step 550 can also include a separation of filtrate from solids via centrifuges. The third crystallization step 550 can comprise a waste flow 560 and an outstream flow 570 exiting the third crystallization step 550. The crystals in the waste flow 560 can then be dewatered and washed to create a liquor that is then sent to the next chemical precipitation step 580 or recycled to the concentration step 470.

Filtrate flow 570 can then flow to the chemical precipitation step 580. The chemical precipitation step 580 can comprise mixing the filtrate flow 570 with a caustic material stream 575 such as a 25 wt. % milk-of-lime slurry to adjust the pH to approximately 11 to precipitate magnesium as magnesium hydroxide while a corresponding amount of sulfate is removed as coprecipitated calcium sulfate or hydrates thereof. In the current aspect, “approximately” for a pH value is defined as a range of +0.5. Magnesium can be precipitated to about 5 ppm in a single agitated tank with a retention time of 1 hour. Calcium can remain at the gypsum saturation level. The slurry can undergo solid/liquid separation to generate the magnesium hydroxide stream 590, which can be a stream of solids that can be recycled from the downstream precipitation step to the neutralization step 450. The outflow solution 600 may comprise substantially less magnesium and potassium than the incoming solids 410 while retaining over 90% recovery of the lithium.

The process illustrated in FIG. 3 can result in over 90% recovery of lithium from the solids, over 80% of magnesium removed as magnesium sulfate, and over 30% of potassium removed as potassium sulfate.

The processes as illustrated in FIG. 1, FIG. 2, and FIG. 3 can contain more crystallization steps for optimization of process costs and higher recovery of lithium.

FIG. 4a, FIG. 4b, FIG. 4c, FIG. 4d, and FIG. 4e are ternary diagrams of lithium sulfate, potassium sulfate, and magnesium sulfate at various temperatures. Specifically, the ternary diagrams are for pure salts in water. The actual diagrams for these salts in the filtrate and brine with more impurities or other solution can vary. Specifically, these diagrams give a ratio of where crystallization occurs for sulfate solutions of these salts. In the claimed process, lesser impurities such as sodium, iron, or aluminum can be present and affect this data.

One should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

It should be emphasized that the above-described aspects are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described aspect(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A method for reducing alkali earth metals in a chemical filtrate comprising:
crystallizing alkali earth cations in the chemical filtrate in a first crystallization step; and
crystallizing alkali earth cations in the chemical filtrate in a second crystallization step,
wherein the first crystallization step occurs in a forced circulation crystallizer, and
wherein the second crystallization step occurs in a first draft tube crystallizer.

2. The method for reducing alkali earth metals in a chemical filtrate of claim 1, further comprising crystallizing impurities in a third crystallization step, wherein the third crystallization step occurs in a second draft tube crystallizer.

3. The method for reducing alkali earth metals in a chemical filtrate of claim 2, wherein the second crystallization step operates at a temperature range of between 30° C. and 50° C., and wherein the third crystallization step operates at a temperature between 1° C. and 20° C.

4. The method for reducing alkali earth metals in a chemical filtrate of claim 3, wherein the second crystallization step operates at a temperature of approximately 40° C. and wherein the third crystallization step operates at a temperature of approximately 10° C.

5. The method for reducing alkali earth metals in a chemical filtrate of claim 4, wherein the first crystallization step operates at a temperature of approximately 65° C.

6. A method for reducing magnesium in a chemical liquor comprising:
crystallizing magnesium into a magnesium sulfate hydrate in a first crystallization step; and
precipitating magnesium via addition of a caustic material in a chemical precipitation step.

7. The method for reducing magnesium in a chemical liquor of claim 6, further comprising:
crystallizing magnesium into a magnesium sulfate hydrate in a second crystallization step;
removing the magnesium sulfate hydrate from the first crystallization step and second crystallization step; and
precipitating the magnesium in the chemical precipitation step into magnesium hydroxide by addition of milk-of-lime to adjust a pH of the chemical liquor to between 10.5 and 11.5.

8. The method for reducing magnesium in a chemical liquor of claim 7, wherein first crystallization step further comprises crystallizing potassium into potassium sulfate, potassium sulfate hydrates, magnesium potassium sulfate, magnesium potassium sulfate hydrates, magnesium potassium double salts, or combinations thereof, and wherein second crystallization step further comprises crystallizing potassium into potassium sulfate, potassium sulfate hydrates, magnesium potassium sulfate, magnesium potassium sulfate hydrates, magnesium potassium double salts, or combinations thereof.

9. The method for reducing magnesium in a chemical liquor of claim 7, wherein the first crystallization step operates at a temperature of approximately 40° C., and the second crystallization step operates at a temperature of approximately 10° C.

10. The method for reducing magnesium in a chemical liquor of claim 9, wherein the first crystallization step occurs in a forced circulation crystallizer, and the second crystallization step occurs in a first draft tube crystallizer.

11. The method for reducing magnesium in a chemical liquor of claim 9, wherein the first crystallization step is via evaporative crystallization, and wherein the second crystallization step is via cooling crystallization.

12. A method for reducing alkali earth metals in solids comprising:
acid-leaching the solids to form an effluent slurry;
neutralizing the effluent slurry to form a neutralized filtrate;
concentrating the neutralized filtrate by Mechanical Vapor Recompression heated falling film evaporators;
crystallizing impurities from the neutralized filtrate in a first crystallization step in a forced circulation crystallizing step;
crystallizing impurities from the neutralized filtrate in a second crystallization step in a first draft tube crystallizing step;
crystallizing impurities from the neutralized filtrate in a third crystallization step in a second draft tube crystallizing step; and
precipitating remaining impurities via addition of a caustic material.

13. The method for reducing alkali earth metals in solids of claim 12, wherein the acid leaching of the solids uses sulfuric acid, and wherein a temperature of the acid leaching of the solids is between 75° C. and 90° C.

14. The method for reducing alkali earth metals in solids of claim 13, wherein the caustic material is milk-of-lime, and wherein the precipitated impurity is magnesium hydroxide.

15. The method for reducing alkali earth metals in solids of claim 14, wherein the magnesium hydroxide is recycled to neutralize the effluent slurry.

16. The method for reducing alkali earth metals in solids of claim 12, wherein a lithium concentration is held below a lithium target concentration when the neutralized filtrate leaves the Mechanical Vapor Recompression heated falling film evaporators.

17. The method for reducing alkali earth metals in solids of claim 12, wherein:
the Mechanical Vapor Recompression heated falling film evaporators evaporate the neutralized filtrate at approximately 105° C.;
the first crystallization step occurs at approximately 65° C.;
the second crystallization step occurs at approximately 40° C.; and
the first crystallization step occurs at approximately 10° C.

18. The method for reducing alkali earth metals in solids of claim 17, wherein the second crystallization step is cooled by water from a cooling tower.

19. The method for reducing alkali earth metals in solids of claim 18, wherein the third crystallization step is cooled with a glycol-water mixture.

20. The method for reducing alkali earth metals in solids of claim 19, wherein the glycol mixture comprises ethylene glycol.
